(19) United States
(12) Patent Application Publication
(10) Pub. No.: US 2013/0209347 A1
(43) Pub. Date: Aug. 15, 2013

(54) GAS TO GAS HEAT EXCHANGER

(71) Applicant: Christopher L. Harris, Houston, TX (US)

(72) Inventor: Christopher L. Harris, Houston, TX (US)

(73) Assignee: WILLIAM MARSH RICE UNIVERSITY, Houston, TX (US)

(21) Appl. No.: 13/806,813

(22) PCT Filed: Jun. 24, 2011
(86) PCT No.: PCT/US2011/041911

§ 371 Date: Apr. 22, 2013

Related U.S. Application Data
(60) Provisional application No. 61/358,341, filed on Jun. 24, 2010.

(51) Int. Cl. F28D 7/02; C01B 31/02

(52) U.S. Cl. CPC F28D 7/02; C01B 31/0226
USPC 423/447.3; 165/135; 165/104.13; 422/600

(57) ABSTRACT

A gas to gas heat exchanger, such as use in a HiPco system, and an improved system and process by which gas from the gas to gas heat exchanger and the gaseous catalyst carrier stream can be introduced into the HiPco core reactor.

### CROSS-REFERENCE TO RELATED PATENT APPLICATIONS

This application claims priority to provisional U.S. Patent Application Ser. No. 61/358,341, filed on Jun. 24, 2010, entitled “Gas To Gas Exchanger For HiPco Reactor,” which provisional patent application is commonly assigned to the assignee of the present invention and is hereby incorporated herein by reference in its entirety for all purposes.

### FIELD OF THE INVENTION

The present invention relates to a gas to gas heat exchanger, such as for a gas to gas heat exchanger for a HiPco system. The present invention further relates to an improved system and process by which gas from the heat exchanger and the gaseous catalyst carrier stream can be introduced into the HiPco core reactor.

### BACKGROUND OF THE INVENTION

U.S. Pat. No. 6,761,870, entitled “Gas-Phase Nucleation And Growth of Single-Wall Carbon Nanotubes From High Pressure CO” issued to Smalley et al., Jul. 13, 2004 (the “Smalley '870 patent”), discloses a process of supplying high pressure (e.g., 30 atmospheres) CO that has been preheated (e.g., to about 1000° C.) and a catalyst precursor gas (e.g., Fe(CO)₅) in CO that is kept below the catalyst precursor decomposition temperature to a mixing zone. In this mixing zone, the catalyst precursor was rapidly heated to a temperature that results in (1) precursor decomposition, (2) formation of active catalyst metal atom clusters of the appropriate size, and (3) favorable growth of single wall carbon nanotubes (“SWNTs”) on the catalyst clusters. Generally, a catalyst cluster nucleation agency was employed to enable rapid reaction of the catalyst precursor gas to form many small, active catalyst particles instead of a few large, inactive ones. Such nucleation agencies could include auxiliary metal precursors that cluster more rapidly than the primary catalyst, or through provision of additional energy inputs (e.g., from a pulsed or CW laser) directed precisely at the region where cluster formation is desired. Under these conditions, SWNTs nucleated and grew according to the Boudouard reaction. The SWNTs thus formed could be recovered directly or passed through a growth and annealing zone maintained at an elevated temperature (e.g., 1000° C.) in which tubes may continue to grow and coalesce into ropes. Such process is referred to as the “HiPco process” and the core reactor that such a HiPco process takes place can be referred to as a HiPco core reactor.

The HiPco process is also described in Bronikowski, et al., “Gas-phase production of carbon single-walled nanotubes from carbon monoxide via the HiPco process: A parametric study,” J. Vac. Sci. Technol. A, vol. 19. No. 4, 1800-1805 (2001).

FIG. 1 is a schematic representation of a form of the HiPco process. As shown in FIG. 1, one embodiment of the HiPco process involved the supply of high pressure CO from a suitable source shown as CO supply vessel 101. After optional cleanup in filtration unit 102, the high pressure CO was divided into undiluted stream 103 and catalyst carrier stream 104. An additional stream 119 could also be provided. Catalyst precursor was supplied via stream 105 from a suitable source, shown as catalyst supply vessel 106. A catalyst-containing CO stream 107 was then formed by combining streams 104 and 105.

The gas phase process of the present invention operates at high (i.e., superatmospheric) pressure. Since the gaseous reactants are predominantly CO, the reaction pressure parameters can be best discussed in terms of the partial pressure of CO, i.e., P_{CO}. In general, it is preferred to employ P_{CO} in the range of from about 3 to about 1000 atmospheres (such as 30 atmospheres). Likewise, the catalyst precursor feed concentration is expressed in terms of its partial pressure, P_{cat}, and is typically in the range between about 250 mTorr and 100 Torr. As taught in Smalley '870 patent, higher P_{cat} values were often employed as P_{CO} was increased.

Catalyst-containing stream 107 and undiluted Co stream 103 were forwarded to a mixing zone 108. Stream 103 was generally preheated before or in combination with its introduction into the mixing zone. Such preheating of the undiluted CO stream 103 could be performed using heat exchanger 120 (including the prior designed heat exchangers previously utilized for HiPco processes). Any other suitable means that can be normally employed to preheat gas streams could alternatively be employed. Generally, the heat exchanger would heat the undiluted stream at to or above about 600° C.

As discussed below, the preheated undiluted CO stream 103 is further heated within core reactor 110 to a temperature sufficient to result in a reaction mixture, after combining with catalyst precursor/CO stream 107, which was rapidly and uniformly heated to a temperature that favored near simultaneous catalyst cluster formation and single wall carbon nanotube growth via the Boudouard reaction. This reaction temperature generally was in the range of about 850° C. to about 1250° C. Accordingly, CO stream 103 generally would be further heated in the core reactor 110 to the range of from about 850° C. to about 1500° C.

Stream 107 would generally be kept below the decomposition temperature of the catalyst precursor. This could be accomplished, if necessary, by using known cooling methods such as air or water cooling. Generally, the catalyst/CO stream 107 was kept at a temperature below 200° C., and typically was maintained at a temperature in the range of from about 70° C. to 200° C. If the temperature exceeded the catalyst decomposition temperature, clusters can form too early in the process and become inactivated before they can participate in the single wall carbon nanotube growth process. The temperature range would vary depending on the precise catalyst or catalyst mixture employed.

Streams 103 and 107 were then combined in mixing zone 108 of core reactor 110 (also referred to as the reactor) where nucleation and growth of single wall carbon nanotubes took place. The mixing zone 108 was configured to provide rapid mixing of preheated CO stream with catalyst precursor containing stream 107. As this mixing took place, the catalyst precursor stream was rapidly heated to a temperature in the range of from about 900-1000° C. in some processes. Extremely short mixing times were desired and can be referred to as nearly simultaneous. These mixing times were generally below about 1 msec and typically on the order of 1 to 100 μsec. The object of this fast mixing was the fast and uniform heating of the catalyst precursor. Accordingly, turbulent mixing conditions were preferred since heat transfer was promoted thereby. As a result of these rapid mixing conditions, the volume of the mixing zone would not be large. Typically, complete mixing/heating was accomplished in a volume on the order of 1 cm or less. Flow rates to the mixing zone could be controlled for a given mixing zone configuration to provide the requisite turbulence and were typically subsonic although supersonic mixing could be employed.

The mixture of single wall carbon nanotubes freely suspended in gas leaving the mixing zone entered growth and annealing zone 109. This zone was generally kept at an elevated temperature by enclosing it in a core reactor 110 (also referred to as a “reactor” or “oven”), containing heating elements 111 of any suitable kind. Core reactor 110 was generally maintained at a temperature of from about 850° C. to 125° C. and typically was maintained at a temperature of about 1000° C. Core reactor 110 was generally supplied with a pressure equalizing gas, e.g., N₂ from supply vessel 112. The pressure of the pressure equalizing gas generally was kept lower than the pressure of the CO process gas to ensure a majority CO gas balance in the process.

In the growth and annealing zone, additional growth of previously formed single wall carbon nanotubes could take place, as may the formation of new tubes. In this zone, the formed tubes could also aggregate and remain bound to one another by van der Waals forces to form ropes (i.e., up to about 10³ or more tubes in generally parallel alignment).

After leaving growth and annealing zones, the mixture of gas (primarily unreacted CO and CO₂) containing suspended single wall carbon nanotube products (mostly ropes) was forwarded to a product recovery zone 112. In the product recovery zone, the solid product 113 was removed from the gas stream by any suitable means and the separated gas stream 114 could be recycled. Product separation could be accomplished by any known gas/solids separation means including filtration or the like. To facilitate continuous operation, an endless belt or drum-type filter carrier could be employed in a known manner.

Recycle gas stream 114 could be forwarded to supply vessel 101. Generally, intermediate steps could include CO₂ removal at 115 and storage in low-pressure supply vessel 116. The low pressure CO could be recompressed with any suitable means shown at 117 and then forwarded to high-pressure storage vessel 101.

The prior heat exchangers utilized in the HiPco systems had a safety ratio of less than 0.6, and also encountered stress that required constant inspection, replacement, and repair of the heat exchangers. Moreover, the time to make the replacements and repair of the heat exchanger caused significant downtime resulting in less production of the single-wall carbon nanotubes by the HiPco systems. Accordingly, there is a need for an improved gas to gas heat exchanger for use in high pressure, high temperature gas (particularly caustic gases like CO) that are more efficient, are safer (increased safety factor), have longer intervals between repair and/or replacement (increased duty cycle), have increased quality of the throughput (better material property control), have improved material handling and packaging properties, and are economical (less expensive).

Furthermore, as noted above, it is desired that mixing zone 108 of core reactor 110 is configured to provide rapid mixing of preheated CO stream with catalyst precursor containing stream 107. FIG. 2 is a schematic of the core reactor 110 shown in FIG. 1. Core reactor 110 could be a cylindrical aluminum pressure vessel containing electrical resistance heating element 111 (such as a resistive pyrolytic rod) surrounded by insulating material (not shown) in the central portion. Other materials and heating methods could be employed as was known in the art. Heating element 111 and other materials and heating methods employed within the core reactor 110 are used to heat the preheated undiluted CO feedstream 103 (such as from the heat exchanger 120) to the desired temperature (i.e., in the range of from about 850° C. to about 1500° C.). Suspended in axial orientation in core reactor 110 was a reactor tube 201. This reactor tube 201 generally included both the mixing zone 108 and growth and annealing zone 109. Tube 201 was generally quartz. Undiluted CO feed stream 103 in this embodiment entered the core reactor 110 near the exit and was passed countercurrently through conduit 202 at the periphery of the growth and annealing zone 109 to supply CO to the mixing zone 108, shown in more detail in FIG. 3. This conduit 202 was typically a copper coil of spirally wound tubing. This configuration employed the heat in the quartz tube (from the mixing zone 108 and growth annealing zone 109) to preheat the CO gas stream fed to mixing zone 108.

FIG. 3 is a schematic of a magnified portion of the mixing zone 108 of core reactor 110 showing in FIG. 2. As shown in FIG. 3, a portion of the reactor tube 201 is shown in the vicinity of mixing zone 108. The catalyst precursor/CO stream 103 entered via stainless steel tube 301, which was water-cooled by jacket 302. Tube 301, which was typically quartz, delivered the catalyst precursor/CO feed mixture directly into mixing area 304. The countercurrent undiluted CO flow in tube 202 was connected to manifold 305, through which nozzle 303 also protruded. Manifold 305 was typically stainless steel, graphite, or the like. In manifold 305, the CO stream was redirected tangentially to the axial flow from nozzle 303 and supplied to mixing area 304 through a plurality of radially disposed tangentially directed injectors 306.

In view of the method by which the single wall carbon nanotubes are produced in the HiPco process, there is a need for an improved injection of the gas streams into the HiPco core reactor.

### SUMMARY OF THE INVENTION

In general, in one aspect, the invention features a heat exchanger that includes a first heat exchanger tube, a second heat exchanger tube, a pressure vessel tube, insulating material, and pressurizing flow tubes. The first heat exchanger tube is positioned coaxially within the second heat exchanger tube. The second heat exchanger tube is positioned coaxially within the pressure vessel tube. The first heat exchanger tube and the second exchanger are positioned to allow heat to be exchanged therebetween. An annular space is formed between the pressure vessel tube and the second heat exchanger tube. The first heat exchanger tube is not fixed to the second heat exchanger tube and the pressure vessel tube such that the first heat exchanger tube is operable for moving with respect to the second heat exchanger tube and the pressure vessel tube when exposed to a first fluid having a thermal gradient. The second heat exchanger tube is not fixed to the first heat exchanger tube and the pressure vessel tube such that the second heat exchanger tube is operable for moving with respect to the first heat exchanger tube and the pressure vessel tube when exposed to a second fluid having a thermal gradient. The insulating material is positioned between the second heat exchanger tube and the pressure vessel tube. The pressurizing flow tubes are operatively connected to the annular space. The pressurizing flow tubes are operable for flowing a pressurizing gas in the annular space to provide (a) low relative pressure in the first exchanger tube, (ii) low relative pressure in the second exchanger tube, and (iii) high relative pressure in the pressure vessel tube.

Implementations of the inventions can include one or more of the following features:

The heat exchanger can be operable for flowing the first fluid at high absolute pressure and high temperature through the first heat exchanger tube while maintaining the low relative pressure in the first heat exchanger tube. The heat exchanger can further be operable for flowing the second fluid at high absolute pressure and high temperature through the second heat exchanger tube while maintaining the low relative pressure in the second heat exchanger tube. The heat exchanger can further be operable for maintaining the high relative pressure and low temperature of the pressure vessel tube while flowing the first fluid at high absolute pressure and high temperature through the first heat exchanger tube and while flowing the second fluid at high absolute pressure and high temperature through the second heat exchanger tube.

The pressure vessel tube can be at least a portion of the outside casing of the heat exchanger.

The heat exchanger can further include an output pressure tube. The output pressure tube can be positioned coaxially around at least a portion of the second heat exchanger tube. The first heat exchanger tube can be not fixed to the output pressure tube such that the first heat exchanger tube is operable for moving with respect to the output pressure tube when exposed to a first fluid having a thermal gradient. The second heat exchanger tube can be not fixed to the output pressure tube such that the second heat exchanger tube is operable for moving with respect to the output pressure tube when exposed to a first fluid having a thermal gradient.

The output pressure tube can be secured to one end of the pressure vessel tube. The output pressure tube can be operable to maintain a high absolute pressure for at least a portion of the heat exchanger.

The first fluid can be a first gas. The second fluid can be a second gas. The first gas and the second gas can be the same type of gas or a different type of gas.

The first heat exchanger material can include a first material. The second heat exchanger materials can include a second material. The first material can be different than the second material.

At room temperature and pressure, the first material can have a thermal expansion coefficient that is at least about 25% different than the thermal expansion coefficient of the second material. At room temperature and pressure, the thermal expansion coefficient of the first material and the thermal expansion coefficient of the second material can be at least about 50% different.

At room temperature and pressure, the first material can be more thermally conductive than the second material. At room temperature and pressure, the ratio of thermal conductivity between the first material and the second material can be at least about 15:1.

The first fluid can be a first gas. The first heat exchanger tube can include a metal operable for flowing the first gas at high temperature.

The first gas can include CO.

The first fluid can be caustic.

The first heat exchanger tube can include copper.

The second fluid can be a second gas. The second heat exchanger tube can include a metal operable for flowing the second gas at high temperature.

The second gas can include CO.

The second fluid can be caustic.

The second heat exchanger tube can include titanium.

The high temperature can be at least about 400° C. The high temperature can be at least 500° C. The high temperature can be at least about 600° C.

The low temperature can be at most about 200° C. The low temperature can be at most about 100° C.

The pressure vessel tube can include a material that is operable to withstand a high relative pressure at low temperature conditions.

The pressure vessel tube can include stainless steel.

The output pressure tube can include a material that is operable to withstand a high relative pressure at low temperature conditions.

The output pressure tube can include stainless steel.

The high absolute pressure can be at least about 3 atmospheres. The high relative pressure can be at least about 3 atmospheres.

The high absolute pressure can be at least about 30 atmospheres. The high relative pressure can be at least about 30 atmospheres.

The low absolute pressure can be at most about 1.5 atmospheres. The low relative pressure can be at most about 1.5 atmospheres.

The low absolute pressure can be at most about 1.2 atmospheres. The low relative pressure can be at most about 1.2 atmospheres.

The insulating material can be operable for insulating heat from the second exchanger tube from the pressure vessel tube.

The insulating material can be a high temperature fibrous insulating material.

The high temperature fibrous insulating materials can be packed in a quartz tube.

The heat exchanger can be operable for flowing a pressurizing gas in the annular space to carry away first fluid leaked from the first heat exchanger tube and second fluid leaked from the second heat exchanger tube.

The heat exchanger can be operable for flowing the pressurizing gas through the insulating material.

The heat exchanger can have a safety factor of at least about 2.

In general, in another aspect, the invention features a method that includes flowing a first fluid through a heat first heat exchanger tube of a heat exchanger. The first fluid is at a high absolute pressure and high temperature. A low relative pressure is maintained in the first heat exchanger tube. The method further includes flowing a second fluid through a second heat exchanger tube of the heat exchanger. The second fluid is at a high absolute pressure and high temperature. A low relative pressure is maintained in the second heat exchanger tube. The first heat exchanger tube is positioned coaxially within the second heat exchanger tube. Heat is exchanged between the first fluid flowing through the first exchanger tube and the second fluid while flowing through the second exchanger tube. The method further includes maintaining a high absolute pressure within the heat exchanger. The first heat exchanger tube is positioned coaxially within the pressure vessel tube. The pressure vessel tube is maintained at the high absolute pressure and at a low temperature during the flowing of the first fluid and the flowing of the second fluid. The first heat exchanger tube moves with respect to the second heat exchanger and the pressure vessel tube due to thermal gradients within the heat exchanger and because the first heat exchanger tube is not fixed to the second heat exchanger tube and the pressure vessel tube. The second heat exchanger tube moves with respect to the first heat exchanger and the pressure vessel tube due to thermal gradients within the heat exchanger and because the second heat exchanger tube is not fixed to the first heat exchanger tube and the pressure vessel tube.

Implementations of the above inventions can include one or more of the following features:

The heat exchanger can be used in a HiPco process.

The method can further include flowing the second fluid from the heat exchanger to a HiPco reactor. The second fluid can be a CO process gas.

The method can further include flowing the first fluid from the HiPco reactor to the heat exchanger. The first fluid can be the output product gas stream from the HiPco reactor.

The high temperature can be at least about 400° C. The high temperature can be about 500° C. The high temperature can be about 600° C.

The low temperature can be at most about 200° C. The low temperature can be at most about 100° C.

The high absolute pressure can be at least about 3 atmospheres. The high relative pressure can be least about 3 atmospheres.

The high absolute pressure can be at least about 30 atmospheres. The high relative pressure can be least about 30 atmospheres.

The low absolute pressure can be at most about 1.5 atmospheres. The low relative pressure can be at most about 1.5 atmospheres.

The low absolute pressure can be at most about 1.2 atmospheres. The low relative pressure can be at most about 1.2 atmospheres.

An annular space can be positioned between the second heat exchanger tube and the pressure vessel tube. The method can further include flowing a pressurizing gas in the annual space to carry away first fluid leaked from the first heat exchanger tube and second fluid leaked from the second heat exchanger tube.

An annular space can be positioned between the second heat exchanger tube and the pressure vessel tube. The method can further include flowing a pressurizing gas to provide space the low relative pressure in the first exchanger tube and the low relative pressure in the second exchanger tube.

Insulating material can be positioned within the annular space.

The flowing of the pressurizing gas in the annular space comprises flowing the pressurizing gas through the insulating material.

Any of the heat exchangers (or combinations thereof) described above can be used in the methods described above.

In general, in another aspect, the invention features a core reactor for use in a HiPco process. The core reactor includes a process gas conduit operable for flowing CO process gas into the core reactor and to a reaction zone injector in a mixing zone in the core reactor. The core reactor further includes a catalyst conduit for flowing catalyst into the core reactor and to the reaction zone injector. The catalyst conduit is operable for flowing hot catalyst, cold catalyst, or both. The core reactor further includes the reaction zone injector positioned in the mixing zone. The reaction zone injector is operable for controlling injection of the catalyst into CO process gas in the mixing zone. The reaction zone injector has multiple reaction zones. The core reactor further includes a product conduit for flowing product made during the HiPco process from the CO process gas and catalyst from the core reactor.

Implementations of the above inventions can include one or more of the following features:

The zone injector can be operable for controlling injection of the catalyst by premixing the catalysts with other nucleating agents, pulsing catalyst injections, controlling the temperature of the catalyst, injecting the catalyst at multiple injection sites within the mixing area, controlling the amount of catalyst injected at the multiple sites, controlling the amount of other nucleating agents at multiple sites, controlling the temperature of the catalyst at the multiple injection sites, and combinations thereof.

The reaction zone injector can have seven reaction zones.

The process gas conduit can be operable for flowing the CO process gas through a heating zone before flowing the CO process gas to the reaction zone. The heating element can be positioned in the heating zone

The heating element can be a resistive heater rod. The resistive heater rod can be operable for heating the CO process stream.

In general, in another aspect, the invention features a method that includes flowing CO process gas into a HiPco core reactor to a reaction zone injector positioned within a HiPco core reactor. The method further includes flowing catalyst to the reaction zone injector. The method further includes using the reaction zone injector to controllably inject catalyst at multiple sites within the mixing zone to react with the CO process gas in the mixing zone. The method further includes flowing product made during the HiPco process from the CO process gas and catalyst from the core reactor.

Implementations of the above inventions can include one or more of the following features:

The step of using the reaction zone injector to controllably inject catalyst into the mixing zone can be premixing the catalysts with other nucleating agents, pulsing catalyst injections, controlling the temperature of the catalyst, injecting the catalyst at multiple injection sites within the mixing area, controlling the amount of catalyst injected at the multiple sites, controlling the amount of other nucleating agents at multiple sites, controlling the temperature of the catalyst at the multiple injection sites, and combinations thereof.

The reaction zone injector can have multiple reaction zones.

The reaction zone injector can have seven reaction zones.

The HiPco core reactor can be used continuously for at least about 4000 hours.

The step of sing the reaction zone injector can increase the duty cycle by a factor of at least about 4.

The step of using the reaction zone injector can increase yield of the product per time by a factor of at least about 2.

The heat exchanger that can be used in this method can be any of the heat exchangers (or combinations thereof) described above.

### DESCRIPTION OF DRAWINGS

For a more detailed understanding of the preferred embodiments, reference is made to the accompanying figures, wherein:

FIG. 1 is a schematic of a form of the HiPco process.

FIG. 2 is a schematic of the HiPco core reactor shown in FIG. 1.

FIG. 3 is a schematic of a magnified portion of the mixing zone of the core reactor shown in FIG. 2.

FIG. 4 is schematic view a heat exchanger according to an embodiment of the present invention.

FIG. 5 is schematic view of first end portion 403 of the heat exchanger shown in FIG. 4.

FIG. 6 is a schematic side view of the first end portion of the heat exchanger shown in FIG. 4.

FIG. 7 is a schematic of the cross-section according to line 601 of the first end portion of the heat exchanger shown in FIG. 6.

FIG. 8 is schematic view of the second end portion 404 of the heat exchanger shown in FIG. 4.

FIG. 9 is a schematic view along the longitudinal axis of the second end portion of the heat exchanger shown in FIG. 4.

FIG. 10 is a schematic of the cross-section according to line 901 of the second end portion of the heat exchanger shown in FIG. 9.

FIG. 11 is a schematic side view of the second end portion of the heat exchanger shown in FIG. 4 (connector rotatable flange and connector ferrule not shown).

FIG. 12 is a schematic of the cross-section according to line 1101 of the first end portion of the heat exchanger shown in FIG. 11.

FIG. 13 is a schematic of a reaction zone injector having one reaction zone.

FIG. 14 is a schematic of a reaction zone injector having seven reaction zones according to an embodiment of the present invention.

FIG. 15 is a photograph of a core reactor according to an embodiment of the present invention.

FIG. 16 is a schematic of a cutaway of the reactor according to an embodiment of the present invention.

FIG. 17 is a graph depicting the duty cycle and production rate improvements resulting from embodiments of the present invention.

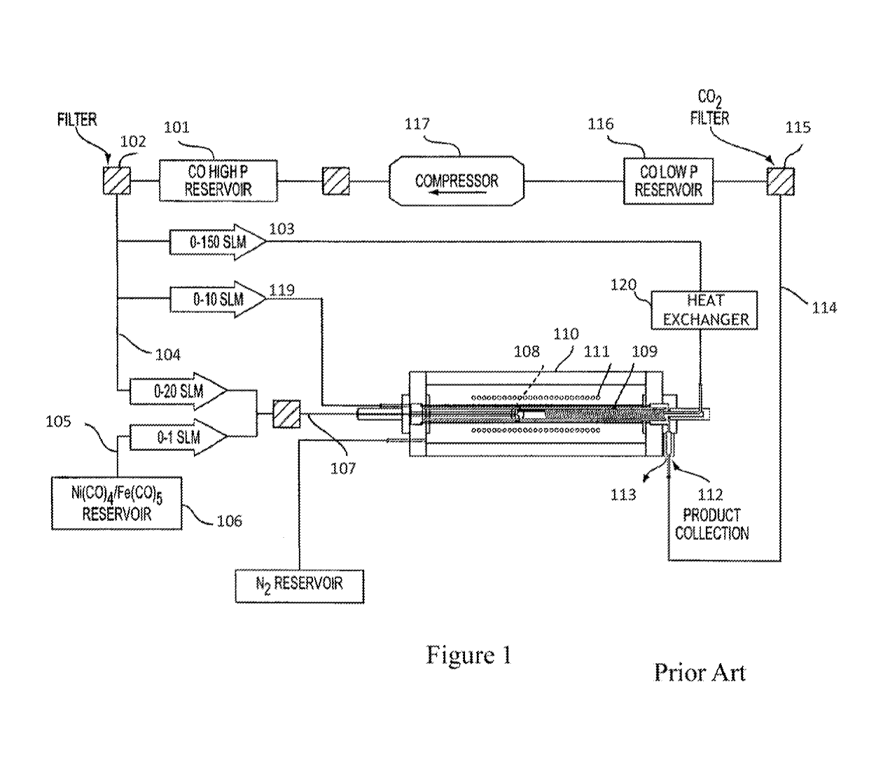

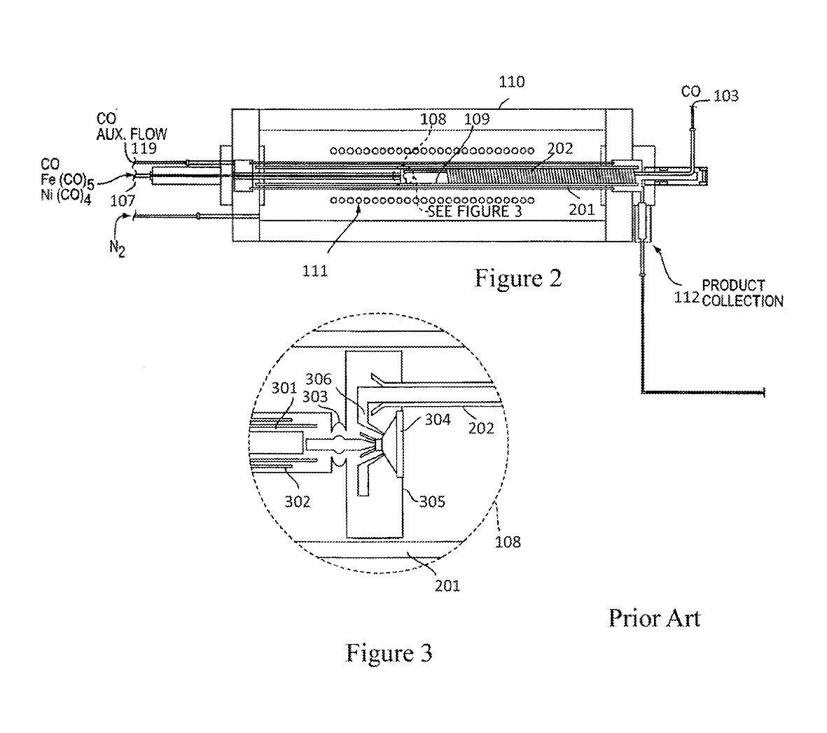

### DETAILED DESCRIPTION

### Heat Exchanger

According to one aspect of the present invention there is provided for a gas to gas heat exchanger, such as for use in a HiPco system. The heat exchanger of the present invention is a device composed of several individual components. The present invention has a unique design, particularly as compared to previous heat exchange devices. While the device of the present invention is directed to the HiPco process and optimized for such use, the device of the present invention has application for any process that requires a heat exchanger utilizing a high pressure, high temperature gas (and particular ones that involve caustic gases, like CO). Thus, while the detailed description of embodiments of the present invention focuses upon the application of the heat exchanger with respect to the HiPco process (and the use of high pressure and high temperature CO), embodiments of the present invention can be used with other processes (and other high pressure and high temperature gases or liquids).

The heat exchanger includes several coaxial tubes and materials designed to move with respect to one another (due to expansion) when exposed to the gases and thermal gradients, such as encountered in the HiPco process.

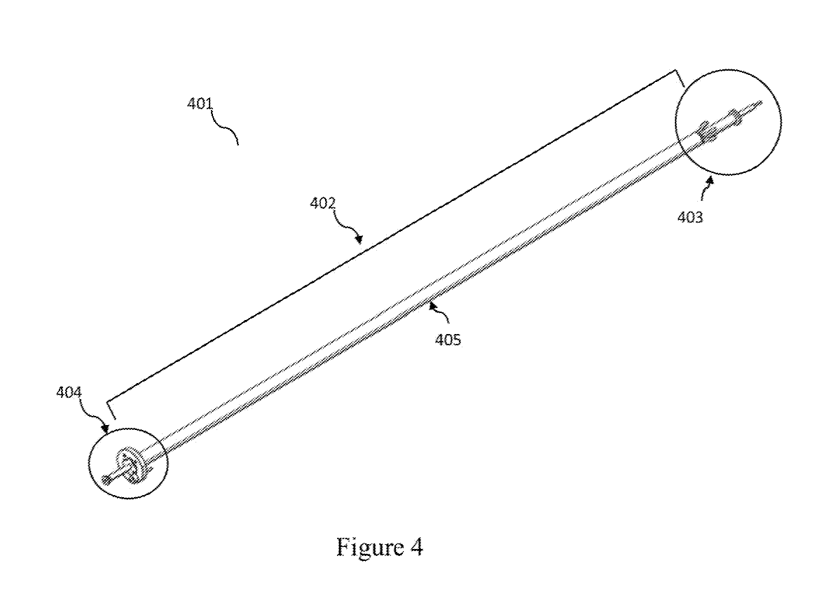

FIGS. 4-12 are schematic views of a heat exchanger according to an embodiment of the present invention. As shown in the embodiment illustrated in FIG. 4, the heat exchanger 401 has a body 402 having a first end 403 and a second end 404. The outer surface of body 402 is a pressure vessel tube 405 that is able to withstand the high pressures of the high pressure gas (or liquid), such as high pressures at or above about 3 atmospheres (including pressures at or above about 30 atmospheres generally utilized in the HiPco process). Generally, such a pressure vessel tube can be made of stainless steel and designed to withstand the highest pressure to be encountered by the heat exchanging (including safety margins). Alternatively, the pressure vessel can be made of any other high strength material that is compatible with the purge gas and that is further compatible with limited low-temperature contact with the process gas or the resultant products. The pressure vessel is also designed to prevent rapid decompression if the main pressure vessel interior is breached.

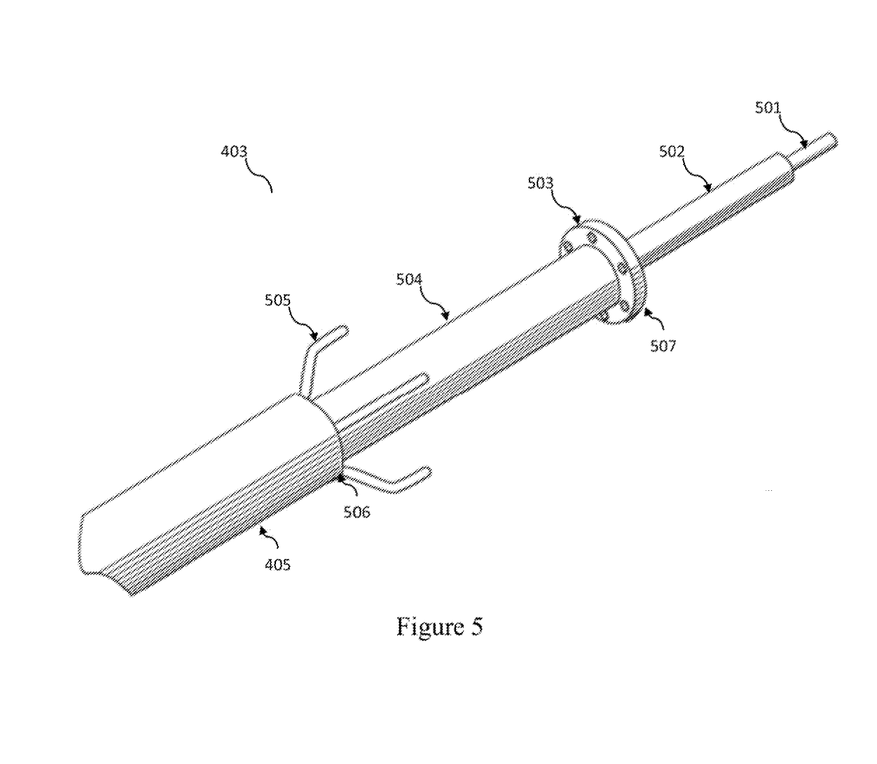

FIG. 5 is schematic view of first end portion 403 of the heat exchanger shown in FIG. 4. The lower left portion of FIG. 5 shows the pressure vessel tube 405. As further shown in FIG. 5, there is a coaxial heat exchanger tube 501 (a final pass CO to CO heat exchanger tube, which can be a copper material), a coaxial heat exchanger tube 502 (a first pass CO to N₂ exchanger tube, which can be a titanium material) and a coaxial output pressure tube 504 (which can be stainless steel), all of which are coaxial to pressure vessel tube 405. It has been found that the coaxial heat exchanger tubes are made of copper and titanium materials, as other materials have failed under the high pressure and high temperature pressure encountered for heat exchanges used in the HiPco process. Such high temperature is typically in excess of about 400° C. As discussed above, the heat exchanger in a HiPco process will generally heat the undiluted stream at to or above about 600° C.

A rotatable flange 507 and a collar 503 (which each can be stainless steel) are positioned where coaxial heat exchanger tube 502 (and the coaxial exchanger tube 501 nested within it) enter into coaxial output pressure tube 504. Coaxial output pressure tube 504 (and the coaxial heat exchanger tubes 501 and 502 nested within it) enter into the pressure vessel tube 405 at flange 506 (first pass rear main flange, which can be stainless steel). As shown in the embodiment of FIG. 5, vent tubes 505 are positioned at flange 506 to allow for purging.

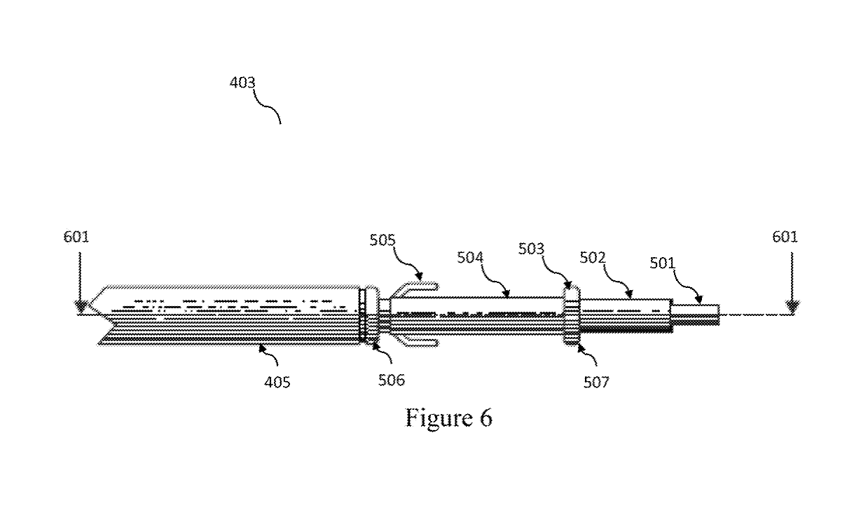

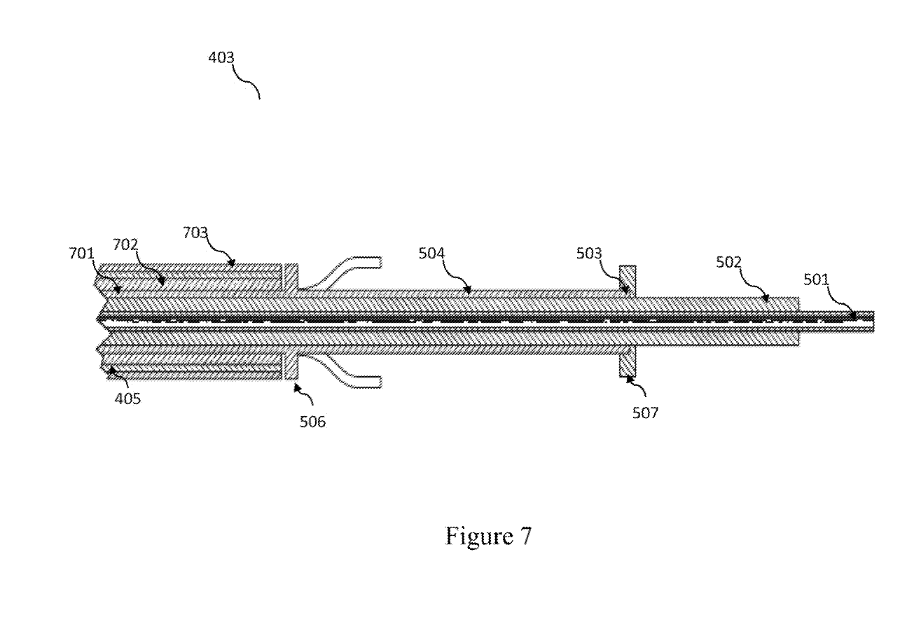

FIG. 6 is a schematic side view of the first end portion 403 of the heat exchanger 401 shown in FIG. 4. FIG. 7 is a schematic of the cross-section according to line 601 of the first end portion 403 of the heat exchanger 401 shown in FIG. 6. As shown in FIG. 7, there is a coaxial heat exchanger tube 702 (first pass N₂ to N₂ heat exchanger tube, which can be a spiral wrapped, fiberfrax material) coaxially positioned between the coaxial output pressure tube 504 and pressure vessel 405. An exchanger tube insulator 701 (CO to N₂ heat exchanger tube insulator, which can be quartz) is coaxially positioned inside the heat exchanger tube 702. Moreover, an insulation compression tube (N2 to N2 heat exchanger tube insulation compression tube, which can be quartz) is coaxially positioned along the pressure vessel tube 405.

By this arrangement, the coaxial heat exchanger tube 501 and coaxial heat exchanger tube 502, can move with respect to one another and with respect to coaxial output pressure tube 504 and pressure vessel tube 405 (due to expansion) when exposed to the gases and thermal gradients, such as encountered in the HiPco process. Thus, the coaxial heat exchanger tubes 501 and 502 float to compensate for thermal expansion.

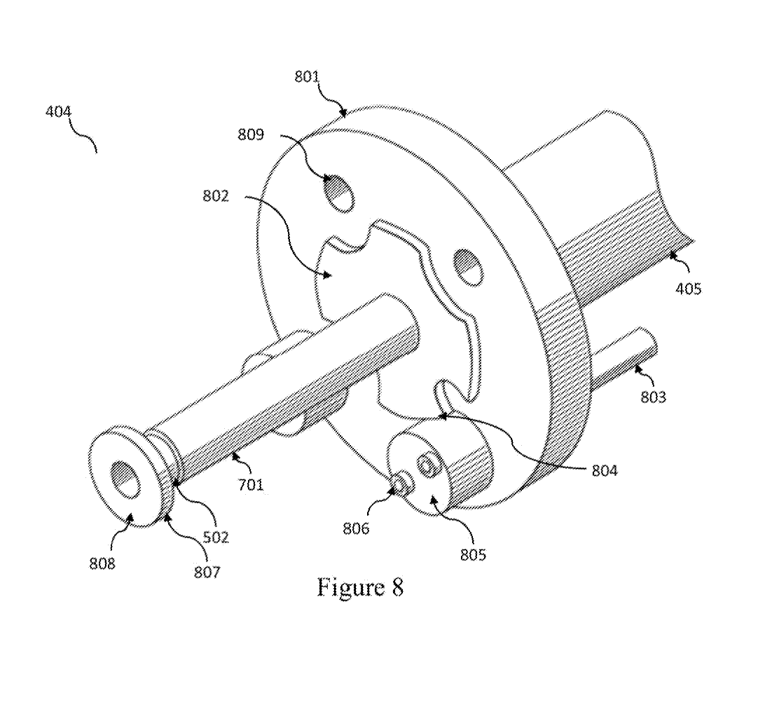

FIG. 8 is schematic view of the second end portion 404 of the heat exchanger shown in FIG. 4. The upper right portion of FIG. 5 shows the pressure vessel tube 405. As further shown by FIG. 8, a flange 801 (rear main vessel flange, which can be stainless steel) is connected to the pressure vessel tube 405, with exchanger tube insulator 701 and coaxial heat exchange tube 502 (as well as coaxial heat exchanger tube 501 (not shown)) passing through flange 801. A rotatable flange 807 (hex connector rotatable flange, which can be stainless steel) and connector ferrule 808 (hex connector ferrule, which can be stainless steel) are connected at the end of second end portion 404, which again provides for coaxial heat exchanger tubes 501 and 502 to float. In embodiments of the invention, this can be done by the machine end of the coaxial heat exchanger tubes 501 and 502 being slip fit to graphite.

The connection at flange 801 includes an insulation retainer 802 (which can be stainless steel). An electrode feedthrough 803 (which can be oxygen free copper) is also positioned at flange 801, with associated electrode flex clamp 804 (which can be oxygen free copper), electrode feedthrough seal clamp 805 (which can be vespel), and head cap screw 806 (which can be titanium). Flange 801 also includes instrument feedthrough holes 809. Electrodes and instruments in the heat exchanger 401 can be used for monitoring and control of the system (such as for flow rates, pressure, temperature, and temperature change of the gases).

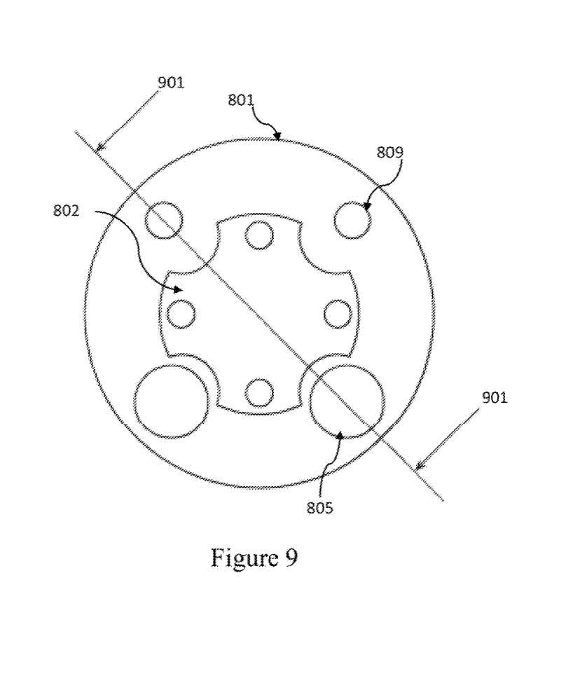

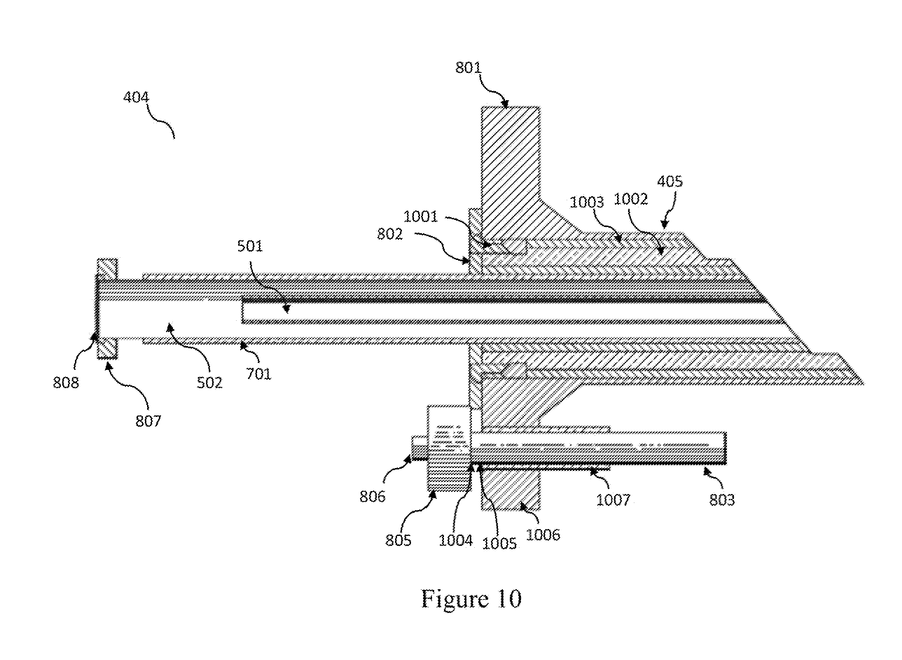

FIG. 9 is a schematic view along the longitudinal axis of the second end portion 404 of the heat exchanger 401 shown in FIG. 4. FIG. 10 is a schematic of the cross-section according to line 901 of the second end portion 404 of the heat exchanger 401 shown in FIG. 9. FIG. 10 further shows a tube slide ring 1001 (CO to N₂ tube slide ring, which can be pressed grafoil) by the insulation retainer 802. Also shown is the insulation compression tube 1003 (N₂ to N₂ heat exchanger tube insulation compression tube which can be quartz) inside the pressure vessel tube 405, and the exchanger tube insulation 1002 (N₂ to N₂ heat exchanger tube insulation, which can be quartz) in its interior. Further shown in FIG. 10 are electrode flex clamp electrode feedthrough o-ring 1004), electrode feedthrough insulator o-ring 1005, flange o-ring 1006 (rear main vessel flange o-ring), and electrode feedthrough insulator 1007 (all of which can be silicone), which are further associated with the electrode feedthrough 803.

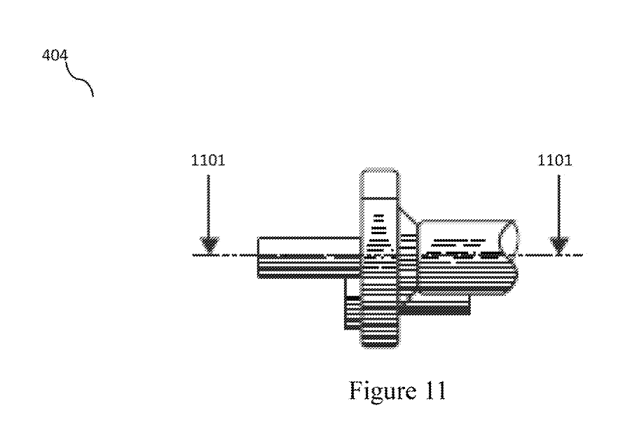

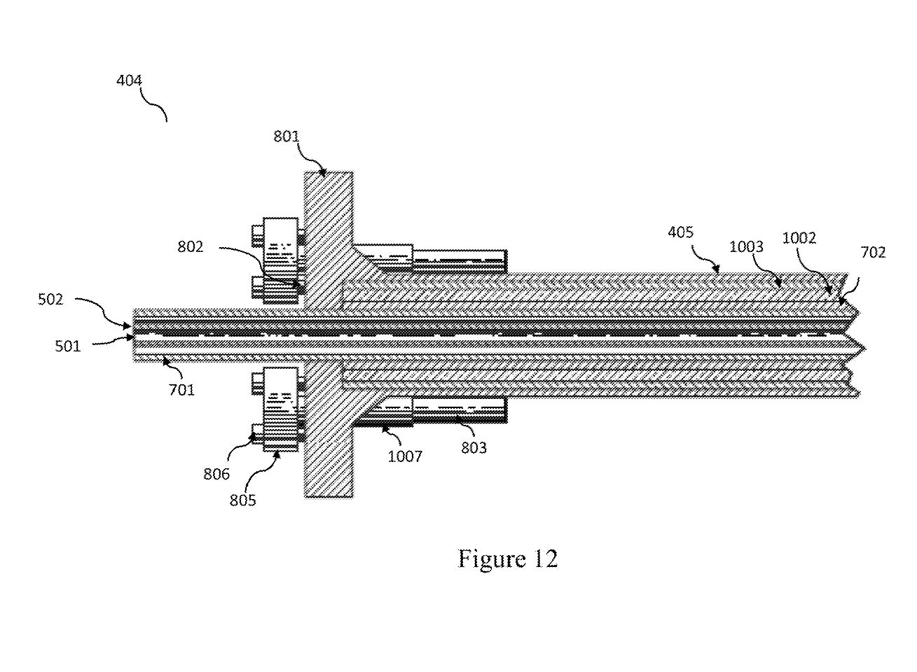

FIG. 11 is a schematic side view of the second end portion 404 of the heat exchanger 401 shown in FIG. 4 (connector rotatable flange and connector ferrule not shown). FIG. 12 is a schematic of the cross-section according to line 1101 of the first end portion 404 of the heat exchanger 401 shown in FIG. 11.

As noted above, and as shown in FIGS. 4-12, the heat exchanger includes several coaxial tubes and materials designed to move with respect to one another (due to expansion) when exposed to the gases and thermal gradients, such as encountered in the HiPco process.

The heat exchanger of embodiments of the present invention is significantly different from a standard tube-in-tube heat exchanger of the prior art. The heat exchange tubes within the exchanger are floating and not a fixed to the outer casing, referred to as the heat exchanger primary pressure vessel (also referred to as the pressure vessel tube). Each inner tube is allowed a significant amount of linear expansion along the length of the heat exchanger. Furthermore, each tube is a different material with significantly different expansion coefficients (at least about a 25% difference at room temperature and pressure). As stand tube-in-tube heat exchangers are coaxial, this new heat exchanger is triaxial. Beginning with the inner most tube (which can be made of pure copper), this tube contains the output product and hot gas flow. The next tube out is a titanium tube, referred to as the heat exchanger secondary pressure vessel, which houses the incoming process gas and separates the CO process gas from the surrounding nitrogen purge gas. These tubes are separated by quartz boats to prevent thermal shorting. This is also one of the reasons the heat exchanger is level on along it long axis to maintain placement of the boats in the annular space described. Between these two tubes is where the primary heat exchange takes place. The next outer layer is quartz tubing that prevents thermal shorting to the next layer. The layer after is a stainless steel tube. This tube is secured by an external weld at the cooler end of the heat exchanger and acts as a pressure vessel for a short length of the exchanger. The next outer layer is a high temperature fibrous insulation packed in to a quartz tube. This annular space also acts as a purge space. A steady low flow of nitrogen provides a low pressure differential for the inner tubes reducing physical stress and carries away any leaking hot CO that may attack the stainless steel pressure vessel and cause degradation of the material. The final outer tube is a stainless steel tube, known as the heat exchange primary pressure vessel, which holds the full pressure of the system, approximately 30 atm, and maintains its safety rating at elevated operating temperatures.

Moreover, while the pressure of the gas inside the most interior exchanger tubes is high, so is the pressure on the exterior of these exchanger tubes. Thus, while the absolute pressure encountered by these interior heat exchanger tubes is high (i.e., as much as 30 atmospheres in the conditions of the HiPco process), the relative pressure encountered by these interior heat exchanger tubes (differential between the pressures at the inside surface and the outside surface of each of the interior heat exchanger tubes, i.e., less than 1.5 atmospheres) is not. (Because the relative pressure is the difference between two pressures, the relative pressure will be expressed as a positive number regardless of which side has the greater pressure. Accordingly, the lowest relative pressure is zero atmospheres). This allows the heat exchanger tubes to be made of materials like copper and titanium, which are excellent materials to use for caustic gases like CO, particular at the high temperatures to which the gases are being heated.

As for the more external tubes, such as output pressure tube 504 and pressure vessel tube 405, the materials used for these is different because they will not be in contact with the caustic gases (like CO) but rather gases like N₂. Moreover, due to insulation, the most exterior tubes (such as output pressure tube 504 and pressure vessel tube 405) will not encounter the high temperatures of the more interior tubes. Hence, a material like stainless steel can be used for these most exterior tubes, as such materials are useful for high pressure, low temperature conditions with non-caustic materials therein (such as low temperatures at or below 200° C.).

In some embodiments of the present invention, the heat exchanger could be used in a cluster or array for use in large HiPco core reactor units or to allow increased flow at high production rates. The embodiments can also be modified to operate at higher operating pressure and temperatures.

For the HiPco process, the heat exchange unit of the present invention contains the CO gas and by-products at up to 30 atmospheres; maintains gas seals to ensure containment; promotes high efficiency heat exchange; ensures structural integrity during exposure of the gas to the catalyst; maintains directional nitrogen purge to remove any CO that lingers to minimize degradation of the primary pressure vessel; provide non explosive leak down path in case of primary vessel breach; and maintain low external primary pressure vessel temperature to maintain safety factor rating.

The heat exchanger of embodiments of the present invention has a factor of safety near 2 and maximum operating conditions, whereas the prior heat exchangers used for the HiPco process (which were not embodiments of the present invention) had a safety rating of less than 0.6. The revised heat exchanger also has components in place that limit gas flow in the event of a pressure vessel breach.

Furthermore, the heat exchanger of the present invention traps heat more efficiently than the prior heat exchangers used in the HiPco process (and processes under like conditions), leading to an increase in overall efficiency and reduction in stress on the core reactor that allows longer intervals between replacement. Furthermore, because the interior coaxial heat exchanger tubes 501 and 502 float within the heat exchanger, the time to repair the heat exchanger is significantly reduced. Indeed, the present design renders the interior coaxial heat exchange tubes readily available for replacement.

The production rate was also improved because of the improved material handling and packaging properties associated a more stable supply of the high pressure and temperature gas.

Additionally, there are other economic advantages for that were obtained by the heat exchanger of the present invention. Because the interior heat exchange tubes are not subjected to high relative pressure, the material costs are much lower. Moreover, because the exterior tubes are not subjected to the high temperature, the amount of heat radiating from the heat exchanger is greatly diminished. Thus, the amount of energy needed to heat a volume of gas (to the same pressure and temperature) is significantly lower in the heat exchanger of the present invention, as compared with the prior heat exchangers previously used at these conditions.

### Improved Injection of Catalyst in HiPco Processes

The present invention further relates to an improved system and process by which the gaseous catalyst carrier stream can injected into the CO process gas in the HiPco core reactor (or HiPco reactor).

As described above, the HiPco core reactor takes the incoming Co process gas (such as from the heat exchanger) and mixes it with catalyst to produce carbon nanotubes plus CO₂. The core reactor outer secondary pressure vessel shell separates the nitrogen and CO spaces. Inside this shell is a graphite heater core reactor that contains the resistive heating rod (pyrolytic rod); immediately after the heating zone or heater is the reaction zone injector that directs the high temperature CO and incoming cooler catalyst gases in a fashion to result in high-speed mixing. During this process, single walled carbon nanotubes (SWNT) are produced. The mixture of remaining CO, single wall carbon nanotubes, and CO₂ exit the core reactor due to incoming gas pressure. The gas goes into the center tube of the heat exchanger.

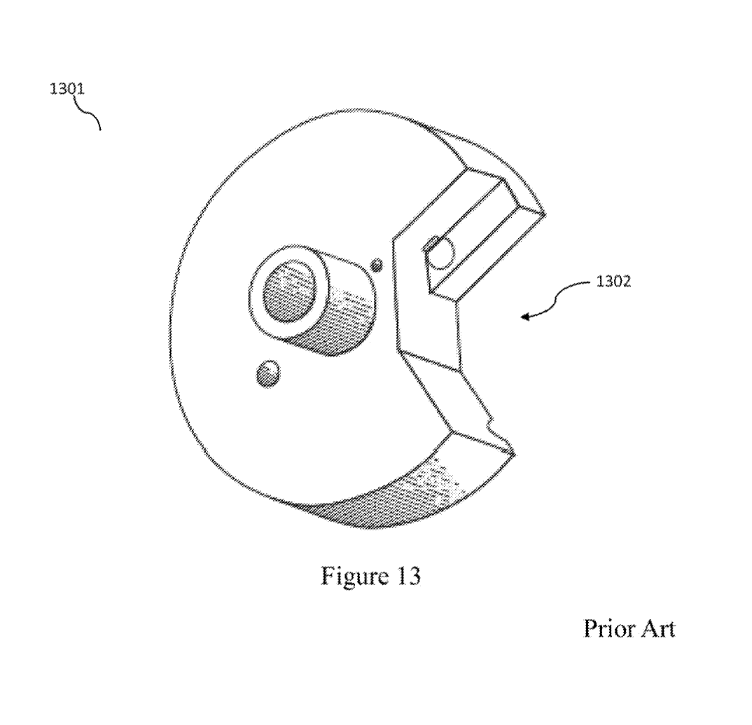

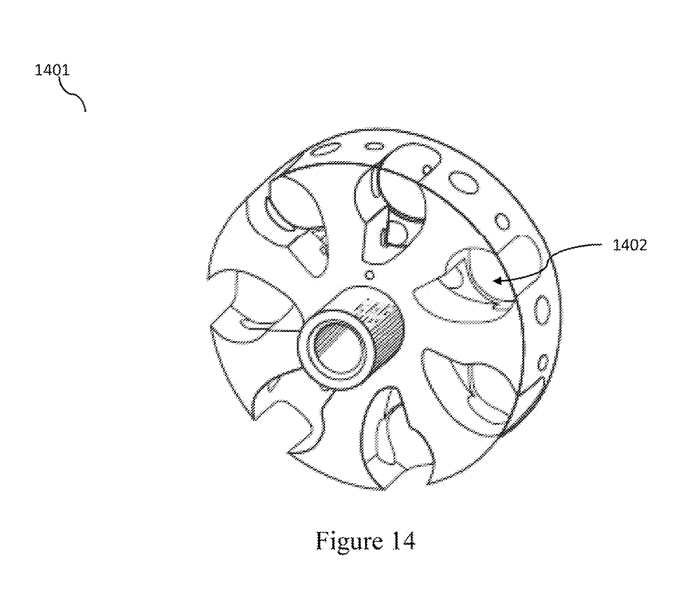

FIG. 13 is a schematic of a reaction zone injector 1301 having one reaction zone 1302. FIG. 14 is a schematic of a reaction zone injector 1401 of an embodiment of the present invention having seven reaction zones 1402. The reaction zone injector 1401 is able to facilitate and direct the injection of the catalyst and CO gas in the core reactor in manners not previously obtained or obtainable.

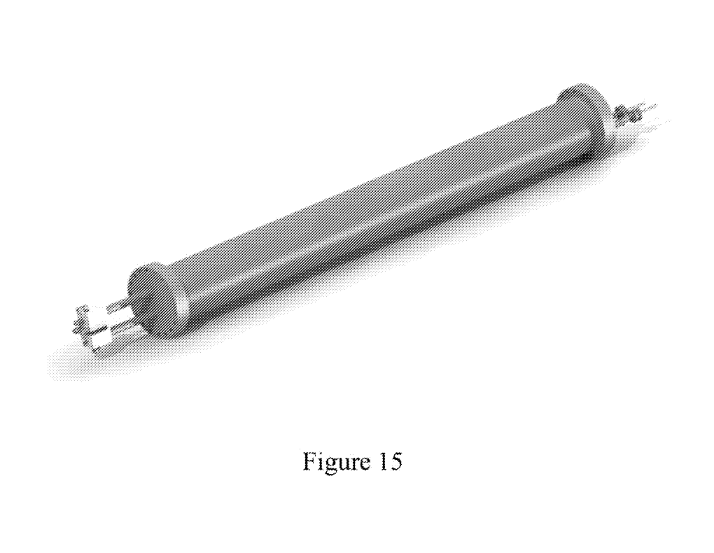

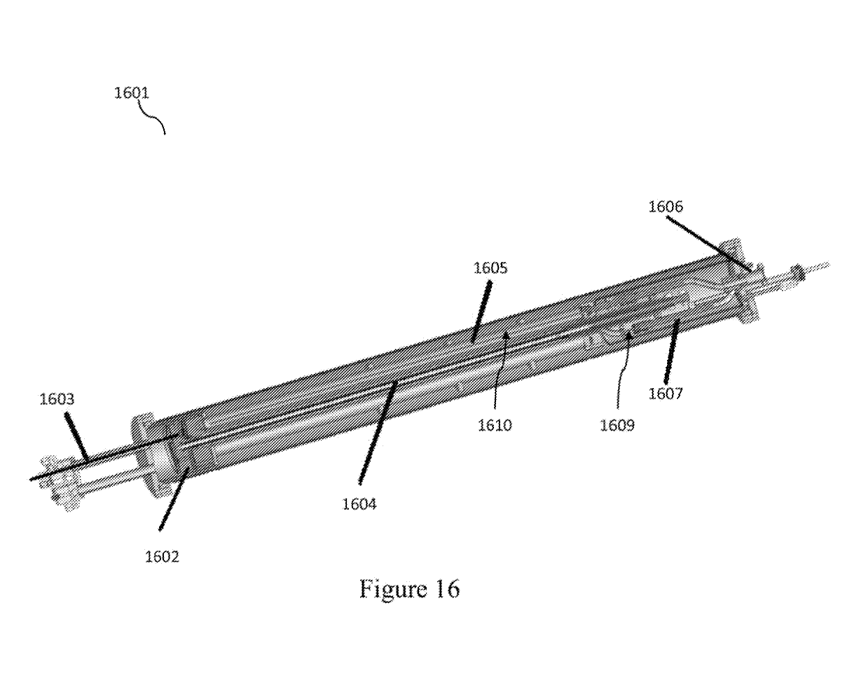

FIG. 15 is a photograph of a core reactor according to an embodiment of the present invention. FIG. 16 is a schematic of a cutaway of core reactor 1601 that includes the reaction zone injector 1602 (also referred to as a showerhead) located by the mixing zone. The catalyst is flown into the core reaction at conduit 1603. The flow path of the catalyst stream as to it travels to the mixing zone is shown by line 1608. (Per the orientation of FIG. 16, the flow path of the catalyst stream is from left to right). Conduit 1603 can be connected to a cold catalyst source that provides catalyst designed to be delivered having a temperature at room temperature or below (i.e., “cold catalyst”) reaction zone injector 1602. Conduit 1603 is also connected to a hot catalyst source that provides catalyst designed to be delivered having an elevated temperature (above room temperature) (i.e., “hot catalyst”) at reaction zone injector 1602.

Core reactor 1601 further includes a connection 1606 to the heat exchanger (from which the high pressure, high temperature CO gas is provided). Conduit 1607 is connected to connection 1606 through which the high pressure, high temperature CO gas flows from the heat exchanger. The flow path of the high pressure, high temperature CO gas as to it travels to resistive heater rod 1604 ((pyrolytic rod) is shown by line 1609. (Per the orientation of FIG. 16, the flow path of the high pressure, high temperature CO gas is from right to left). The resistive heater rod 1604 further heats the high pressure, high temperature gas even further (for example from about 850° C. to about 1500° C.). The high pressure, high temperature CO gas then flows about the resistive heater rod 1604 to the mixing zone and reaction zone injector 1602. The output gas is then flow back to the connection 1606 (and the heat exchanger) through conduit 1605. The flow path of the output gas as to it travels to connection 1606 is shown by line 16010. (Per the orientation of FIG. 16, the flow path of the output gas is from left to right).

The system of core reactor 1601 provides for an increase in catalyst control. The core reactor can now handle catalysts that are generated or delivered at elevated or reduced temperatures, can allow premixing with other nucleating agents, can allow pulse catalyst injections, and provide better control over catalyst conditions (which provides better control over material properties).

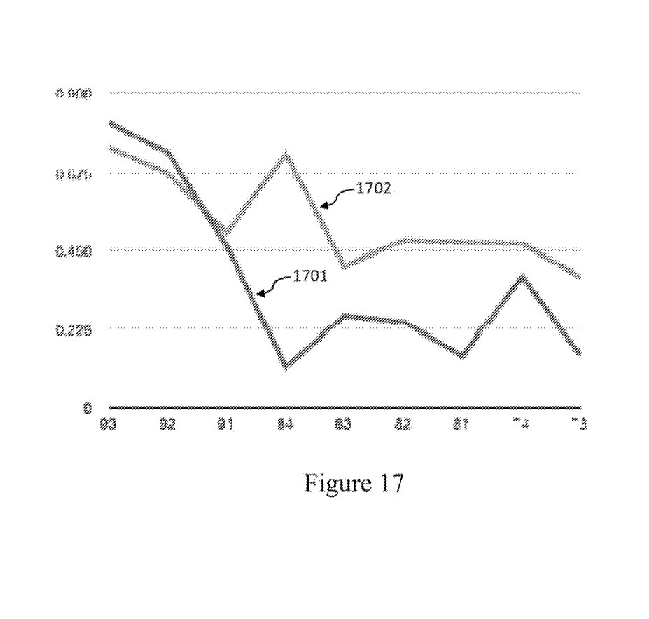

This core reactor system further provides a controlled injection process in which the amount of catalyst injected can be reduced while yielding an increase in the production of the resulting process (carbon nanotubes in the HiPco process). The use of the multi-injection core reactor of the present invention also increased the overall production of the HiPco system, with little increase in input energy (rendering a decrease in the price per amount of product produced). Further, by improving this portion of the system, this provided the ability of the core reactor to withstand long periods of heat and pressure and to recover from loss of power to the heating rod (due to power outages, human error, or otherwise), thereby greatly influence the life-time of the core reactor. FIG. 17 is a graph depicting the duty cycle 1701 and production rate 1702 improvements resulting from embodiments of the present invention. As shown in FIG. 17, the alterations of these elements thus resulted in an increase in duty cycle (how long the instrument runs uninterrupted) of about 4-fold and has been reflected in an increase in yield/time of about 2-fold. Indeed, embodiments of the present invention extended the period of continuous operation of the HiPco system to greater than 4000 hours (half a year).

The disclosures and Figures herein are set forth to more fully illustrate some of the embodiments of the present invention. It should be appreciated by those of skill in the art that the techniques disclosed represent techniques discovered by the inventor to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

Moreover, while various preferred embodiments of the invention have been shown and described, modifications thereof can be made by one skilled in the art without departing from the scope of the invention. The examples described herein are merely illustrative, and are not limiting. Accordingly the scope of protection is not limited by the description set out above, but is only limited by the claims that follow and include all equivalents of the subject matter of the claims. In any method claim, the recitation of steps in a particular order is not intended to limit the scope of the claim to the performance of the steps in that order, or to require completion of one step prior to the commencement of another step, unless so stated in the claim.

The disclosures of all patents, patent applications, and publications cited herein are hereby incorporated herein by reference in their entirety, to the extent that they provide exemplary, procedural, or other details supplementary to those set forth herein.

1. A heat exchanger comprising:
(a) a first heat exchanger tube,
(b) a second heat exchanger tube, wherein
(i) the first heat exchanger tube is positioned coaxially within the second heat exchanger tube, and
(ii) the first heat exchanger tube and the second exchanger are positioned to allow heat to be exchanged therebetween;
(c) a pressure vessel tube, wherein the second heat exchanger tube is positioned coaxially within the pressure vessel tube, wherein
(i) an annular space is formed between the pressure vessel tube and the second heat exchanger tube;
(ii) the first heat exchanger tube is not fixed to the second heat exchanger tube and the pressure vessel tube such that the first heat exchanger tube is operable for moving with respect to the second heat exchanger tube and the pressure vessel tube when exposed to a first fluid having a thermal gradient, and
(iii) the second heat exchanger tube is not fixed to the first heat exchanger tube and the pressure vessel tube such that the second heat exchanger tube is operable for moving with respect to the first heat exchanger tube and the pressure vessel tube when exposed to a second fluid having a thermal gradient;
(d) an insulating material positioned within the annular space; and
(e) pressurizing flow tubes operatively connected to the annular space operable for flowing a pressurizing gas in the annular space to provide (a) low relative pressure in the first exchanger tube, (ii) low relative pressure in the second exchanger tube, and (iii) high relative pressure in the pressure vessel tube.

2. The heat exchanger of claim 1, wherein the heat exchanger is:
(a) operable for flowing the first fluid at high absolute pressure and high temperature through the first heat exchanger tube while maintaining the low relative pressure in the first heat exchanger tube;
(b) operable for flowing the second fluid at high absolute pressure and high temperature through the second heat exchanger tube while maintaining the low relative pressure in the second heat exchanger tube; and
(c) operable for maintaining the high relative pressure and low temperature of the pressure vessel tube while flowing the first fluid at high absolute pressure and high temperature through the first heat exchanger tube and while flowing the second fluid at high absolute pressure and high temperature through the second heat exchanger tube.

3. The heat exchanger of claim 1, wherein the pressure vessel tube is at least a portion of the outside casing of the heat exchanger.

4. The heat exchanger of claim 1, further comprising an output pressure tube, wherein
(a) the output pressure tube is positioned coaxially around at least a portion of the second heat exchanger tube and the pressure vessel tube;
(b) the first heat exchanger tube is not fixed to the output pressure tube such that the first heat exchanger tube is operable for moving with respect to the output pressure tube when exposed to a first fluid having a thermal gradient; and
(c) the second heat exchanger tube is not fixed to the output pressure tube such that the second heat exchanger tube is operable for moving with respect to the output pressure tube when exposed to a first fluid having a thermal gradient.

5. The heat exchanger of claim 4, wherein
(a) the output pressure tube is secured to one end of the pressure vessel tube, and
(b) the output pressure tube is operable to maintain a high absolute pressure for at least a portion of the heat exchanger.

6. The heat exchanger of claim 1, wherein
(a) the first fluid is a first gas,
(b) the second fluid is a second gas, and
(c) the first gas and the second gas can be the same type of gas or a different type of gas.

7. The heat exchanger of claim 1, wherein
(a) the first heat exchanger material comprises a first material,
(b) the second heat exchanger materials comprises a second material, and
(c) the first material is different than the second material.

8. The heat exchanger of claim 7, wherein at room temperature and pressure, the first material has a thermal expansion coefficient that is at least about 25% different than the thermal expansion coefficient of the second material.

9. The heat exchanger of claim 7, wherein, at room temperature and pressure, the thermal expansion coefficient of the first material and the thermal expansion coefficient of the second material are at least about 50% different.

10. The heat exchanger of claim 7, wherein, at room temperature and pressure, the first material is more thermally conductive than the second material.

11. The heat exchanger of claim 10, wherein, at room temperature and pressure, the ratio of thermal conductivity between the first material and the second material is at least about 15:1.

12. The heat exchanger of claim 1, wherein
(a) the first fluid is a first gas, and
(b) the first heat exchanger tube comprises a metal operable for flowing the first gas at a high temperature.

13. The heat exchanger of claim 12, wherein the first gas comprises CO.

14. The heat exchanger of claim 1, wherein the first fluid is caustic.

15. The heat exchanger of claim 1, wherein the first heat exchanger tube comprises copper.

16. The heat exchanger of claim 1, wherein
(a) the second fluid is a second gas, and
(b) the second heat exchanger tube comprises a metal operable for flowing the second gas at high temperature.

17. The heat exchanger of claim 16, wherein the second gas comprises CO.

18. The heat exchanger of claim 1, wherein the second fluid is caustic.

19. The heat exchanger of claim 1, wherein the second heat exchanger tube comprises titanium.

20. The heat exchanger of claim 2, wherein the high temperature is at least about 400° C.

21. The heat exchanger of claim 20, wherein the high temperature is at least about 500° C.

22. The heat exchanger of claim 20, wherein the high temperature is at least about 600° C.

23. The heat exchanger of claim 2, wherein the low temperature is at most about 200° C.

24. The heat exchanger of claim 23, wherein the low temperature is at most about 100° C.

25. The heat exchanger of claim 1, wherein the pressure vessel tube comprises a material that is operable to withstand a high relative pressure at low temperature conditions.

26. The heat exchanger of claim 1, wherein the pressure vessel tube comprises stainless steel.

27. The heat exchanger of claim 4, wherein the output pressure tube comprises a material that is operable to withstand a high relative pressure at low temperature conditions.

28. The heat exchanger of claim 4, wherein the output pressure tube comprises stainless steel.

29. The heat exchanger of claim 2, wherein
(a) the high absolute pressure is at least about 3 atmospheres, and
(b) the high relative pressure is at least about 3 atmospheres.

30. The heat exchanger of claim 29, wherein
(a) the high absolute pressure is at least about 30 atmospheres, and
(b) the high relative pressure is at least about 30 atmospheres.

31. The heat exchanger of claim 2, wherein
(a) the low absolute pressure is at most about 1.5 atmospheres, and
(b) the low relative pressure is at most about 1.5 atmospheres.

32. The heat exchanger of claim 31, wherein
(a) the low absolute pressure is at most about 1.2 atmospheres, and
(b) the low relative pressure is at most about 1.2 atmospheres.

33. The heat exchanger of claim 1, wherein the insulating material is operable for insulating heat from the second exchanger tube from the pressure vessel tube.

34. The heat exchanger of claim 1, wherein the insulating material is a high temperature fibrous insulating material.

35. The heat exchanger of claim 34, wherein the high temperature fibrous insulating materials is packed in a quartz tube.

36. The heat exchanger of claim 1, wherein the heat exchanger is operable for flowing the pressurizing gas in the annular space to carry away first fluid leaked from the first heat exchanger tube and second fluid leaked from the second heat exchanger tube.

37. The heat exchanger of claim 1, wherein heat exchanger is operable for flowing the pressurizing gas through the insulating material.

38. The heat exchanger of claim 1, wherein the heat exchanger has a safety factor of at least about 2.

39. A method comprising:
(a) flowing a first fluid through a heat first heat exchanger tube of a heat exchanger, wherein
(i) the first fluid is at a high absolute pressure and high temperature, and
(ii) a low relative pressure is maintained in the first heat exchanger tube;
(b) flowing a second fluid through a second heat exchanger tube of the heat exchanger, wherein
(i) the second fluid is at a high absolute pressure and high temperature,
(ii) a low relative pressure is maintained in the second heat exchanger tube,
(iii) the first heat exchanger tube is positioned coaxially within the second heat exchanger tube, and
(iv) heat is exchanged between the first fluid flowing through the first exchanger tube and the second fluid while flowing through the second exchanger tube; and
(c) maintaining a high absolute pressure within the heat exchanger, wherein
(i) the second heat exchanger tube is positioned coaxially within a pressure vessel tube,
(ii) the pressure vessel tube is maintained at the high absolute pressure and at a low temperature during the flowing of the first fluid and the flowing of the second fluid,
(iii) the first heat exchanger tube moves with respect to the second heat exchanger and the pressure vessel tube due to thermal gradients within the heat exchanger and because the first heat exchanger tube is not fixed to the second heat exchanger tube and the pressure vessel tube, and
(iv) the second heat exchanger tube moves with respect to the first heat exchanger and the pressure vessel tube due to thermal gradients within the heat exchanger and because the second heat exchanger tube is not fixed to the first heat exchanger tube and the pressure vessel tube.

40. The method of claim 39, wherein the heat exchanger is used in a HiPco process.

41. The method of claim 39, further comprising flowing the second fluid from the heat exchanger to a HiPco reactor, wherein the second fluid is a CO process gas.

42. The method of claim 39, further comprising flowing the first fluid from the HiPco reactor to the heat exchanger, wherein the first fluid is the output product gas stream from the HiPco reactor.

43. The method of claim 39, wherein the high temperature is at least about 400° C.

44. The method of claim 43, wherein the high temperature is at least about 500° C.

45. The method of claim 43, wherein the high temperature is at least about 600° C.

46. The method of claim 39, wherein the low temperature is at most about 200° C.

47. The method of claim 46, wherein the low temperature is at most about 100° C.

48. The method of claim 39, wherein
(a) the high absolute pressure is at least about 3 atmospheres, and
(b) the high relative pressure at least about 3 atmospheres.

49. The method of claim 48, wherein
(a) the high absolute pressure is at least about 30 atmospheres, and
(b) the high relative pressure at least about 30 atmospheres.

50. The method of claim 39, wherein
(a) the low absolute pressure is at most about 1.5 atmospheres, and
(b) the low relative pressure is at most about 1.5 atmospheres.

51. The method of claim 50, wherein
(a) the low absolute pressure is at most about 1.2 atmospheres, and
(b) the low relative pressure is at most about 1.2 atmospheres.

52. The method of claim 39, wherein an annular space is positioned between the second heat exchanger tube and the pressure vessel tube, and the method further comprises flowing a pressurizing gas in the annual space to carry away first fluid leaked from the first heat exchanger tube and second fluid leaked from the second heat exchanger tube.

53. The method of claim 39, wherein an annular space is positioned between the second heat exchanger tube and the pressure vessel tube, and the method further comprises flowing a pressurizing gas to provide the low relative pressure in the first exchanger tube and the low relative pressure in the second exchanger tube.

54. The method of claim 52, wherein insulating material is positioned within the annular space.

55. The method of claim 54, wherein the flowing of the pressurizing gas in the annular space comprises flowing the pressurizing gas through the insulating material.

56. The method of claim 39, wherein the heat exchanger is selected from the group consisting of the heat exchangers of claims 1-37 and 38 and combinations thereof.

57. A core reactor for use in a HiPco process comprising:
(a) a process gas conduit operable for flowing a CO process gas into the core reactor and to a reaction zone injector in a mixing zone in the core reactor,
(b) a catalyst conduit for flowing catalyst into the core reactor and to the reaction zone injector, wherein the catalyst conduit is operable for flowing hot catalyst, cold catalyst, or both;
(c) a reaction zone injector positioned in the mixing zone, wherein
(i) the reaction zone injector is operable for controlling injection of the catalyst into CO process gas in the mixing zone, and
(ii) the reaction zone injector has multiple reaction zones; and
(d) a product conduit for flowing product made during the HiPco process from the CO process gas and catalyst from the core reactor.

58. The core reactor of claim 57, wherein the zone injector is operable for controlling injection of the catalyst selected from the group consisting of premixing the catalysts with other nucleating agents, pulsing catalyst injections, controlling the temperature of the catalyst, injecting the catalyst at multiple injection sites within the mixing area, controlling the amount of catalyst injected at the multiple sites, controlling the amount of other nucleating agents at multiple sites, controlling the temperature of the catalyst at the multiple injection sites, and combinations thereof.

59. The core reactor of claim 57, wherein the reaction zone injector has seven reaction zones.

60. The core reaction of claim 57, wherein
(a) the process gas conduit is operable for flowing the CO process gas through a heating zone before flowing the CO process gas to the reaction zone, and
(b) a heating element is positioned in the heating zone.

61. The core reactor of claims 60, wherein
(a) the heating element comprises a resistive heater rod, and
(b) the resistive heater rod is operable for heating the CO process stream.

62. A method comprising:
(a) flowing CO process gas into a HiPco core reactor to a reaction zone injector positioned in a mixing zone within a HiPco core reactor,
(b) flowing catalyst to the reaction zone injector,
(c) using the reaction zone injector to controllably inject catalyst at multiple sites within the mixing zone to react with the CO process gas in the mixing zone; and
(d) flowing product made during the HiPco process from the CO process gas and catalyst from the core reactor.

63. The method of claim 62, wherein using the reaction zone injector to controllably inject catalyst into the mixing zone is selected from the group consisting of premixing the catalysts with other nucleating agents, pulsing catalyst injections, controlling the temperature of the catalyst, injecting the catalyst at multiple injection sites within the mixing area, controlling the amount of catalyst injected at the multiple sites, controlling the amount of other nucleating agents at multiple sites, controlling the temperature of the catalyst at the multiple injection sites, and combinations thereof.

64. The method of claim 62, wherein the reaction zone injector has multiple reaction zones.

65. The method of claim 64, wherein the reaction zone injector has seven reaction zones.

66. The method of claim 62, wherein the HiPco core reactor is used continuously for at least about 4000 hours.

67. The method of claim 62, wherein using the reaction zone injector increases the duty cycle by a factor of at least about 4.

68. The method of claim 62, wherein using the reaction zone injector increases yield of the product per time by a factor of at least about 2.

69. The method of claim 62, wherein the heat exchanger is selected from the group consisting of the heat exchangers of claims 1-37 and 38 and combinations thereof.
